(19) United States
(12) Patent Application Publication
(10) Pub. No.: US 2007/0083420 A1
(43) Pub. Date: Apr. 12, 2007

(54) Role-based assessment of information technology packages

(76) Inventors: Catherine L. Andresen, Rochester, MN (US); Michael W. Britt, Rochester, MN (US); Thomas D. Christopherson, Rochester, MN (US); Maren E. Nelson, Austin, TX (US); Mark A. Pasch, Rochester, MN (US)

Correspondence Address: MARCIA L. DOUBET LAW FIRM, PO BOX 422859, KISSIMMEE, FL, 34742, US

(21) Appl. No.: 11/244,608

(22) Filed: Oct. 6, 2005

(51) Int. Cl. G06F 17/30

(52) U.S. Cl. 705/10

(57) ABSTRACT

Techniques for assessing information technology packages by comparing a package (including a package still under development) to a set of criteria. Each of the criteria may have one or more attributes, and may be different in priority from one another. In preferred embodiments, an assessment score is created as a result of the comparison. A role-specific perspective may be used for assessing one or more roles supported by aspects of the package. When necessary, a set of recommendations for package changes may be created. The criteria/attributes may be prioritized in view of their importance to the target market, and the assessment results are preferably provided to package teams to influence planning and/or development efforts. Optionally, the assessment process may be used to determine whether at least some predetermined assessment score associated with a special designation has been achieved by the assessed package or aspect(s) thereof.

### CROSS-REFERENCE TO RELATED APPLICATIONS

The present application is related to the following commonly-assigned and co-pending U.S. Patent Applications, which were filed concurrently herewith: Ser. No. 10/______, which is titled “Market-Driven Design of Information Technology Components”; Ser. No. 10/______, which is titled “Assessing Information Technology Components”; and Ser. No. 10/______, which is titled “Selecting Information Technology Components for Target Market Offerings”. The first of these related applications is referred to herein as “the component design application”. The present application is also related to the following commonly-assigned and co-pending U.S. Patent Applications, all of which were filed on May 16, 2003 and which are referred to herein as “the related applications”: Ser. No. 10/612,540, entitled “Assessing Information Technology Products”; Ser. No. 10/439,573, entitled “Designing Information Technology Products”; Ser. No. 10/439,570, entitled “Information Technology Portfolio Management”; and Ser. No. 10/439,569, entitled “Identifying Platform Enablement Issues for Information Technology Products”.

### BACKGROUND OF THE INVENTION

The present invention relates to information technology (“IT”), and deals more particularly with assessing IT packages (including packages still under development) in view of a set of roles of intended users of the packages.

As information technology products become more complex, developers thereof are increasingly interested in use of software component engineering (also referred to as “IT component engineering”). Software component engineering focuses, generally, on building software parts as modular units, referred to hereinafter as “components”, that can be readily consumed and exploited by a higher-level software packaging or offering (such as a software product), where each of the components is typically designed to provide a specific functional capability or service.

Software components (referred to equivalently herein as “IT components” or simply “components”) are preferably reusable among multiple software products. For example, a component might be developed to provide message logging, and products that wish to include message logging capability may then “consume”, or incorporate, the message logging component. This type of component reuse has a number of advantages. As one example, development costs are typically reduced when components can be reused. As another example, end user satisfaction may be increased when the user experiences a common “look and feel” for a particular functional capability, such as the message logging function, among multiple products that reuse the same component.

When a sufficient number of product functions can be provided by component reuse, a development team can quickly assemble products and solutions that produce a specific technical or business capability or result.

One approach to component reuse is to evaluate an existing software product to determine what functionality, or categories thereof, the existing product provides. This approach, which is commonly referred to as “functional decomposition”, seeks to identify functional capabilities that can be “harvested” as one or more components that can then be made available for incorporating into other products.

However, functional decomposition has drawbacks, and mere existence of functional capability in an existing product is not an indicator that the capability will adapt well in other products or solutions.

### BRIEF SUMMARY OF THE INVENTION

The present invention provides techniques for assessing IT packages in view of a set of roles of intended users of the packages. In one preferred embodiment, this comprises: determining a plurality of criteria that are important to a target market, and at least one attribute to be used for measuring each of the criteria; specifying objective measurements for each of the attributes; adapting the criteria, attributes, and measurements for each of one or more roles supported by an IT package to be assessed; and conducting an evaluation of the IT package. Conducting the evaluation preferably further comprises: inspecting a representation of the IT package, with reference to selected ones of the adapted attributes for each of the roles; assigning attribute values to the selected attributes, according to how the IT package compares to the adapted objective measurements for each of the roles; generating an assessment score, for each of the roles, from the assigned attribute values; and generating a list of recommended actions for each of the roles, the list having an entry for each of the selected attributes for which the assigned attribute value falls below a threshold, each of the entries providing at least one suggestion for improving the assigned attribute value. This may further comprise prioritizing each of the adapted attributes in view of its importance to the target market; assigning weights to the adapted attributes according to the prioritizations; and using the assigned weights when generating the assessment score.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will now be described with reference to the following drawings, in which like reference numbers denote the same element throughout.

### BRIEF DESCRIPTION OF THE SEVERAL VIEWS OF THE DRAWINGS

FIG. 1 provides an overview of a role-based package assessment approach, according to preferred embodiments of the present invention;

FIG. 2 provides a chart summarizing a number of sample criteria and attributes for assessing software with regard to particular market requirements;

FIG. 3 depicts example rankings showing the relative importance of requirements for IT purchasers in a sample target market segment;

FIG. 4 shows an example of textual descriptions that may be defined to assist package assessors in assigning values to attributes in a consistent, objective manner;

FIG. 5 provides a flowchart that illustrates, at a high level, actions that are preferably carried out when establishing an assessment process according to the present invention;

FIG. 6 describes performing a package assessment in an iterative manner;

FIG. 7 provides a flowchart that depicts details of how a package assessment may be carried out;

FIG. 8 (comprising FIGS. 8A-8C) contains a sample questionnaire, of the type that may be used to solicit information from a development team whose IT package will be assessed;

FIG. 9 depicts an example of how two different package assessment scores may be used for assigning special designations to assessed packages or aspects thereof; and

FIG. 10 illustrates a sample package assessment report where two role-based perspectives of a package have been assessed and scored, and FIG. 11 shows a sample package assessment summary report.

### DETAILED DESCRIPTION OF THE INVENTION

The present invention provides techniques for assessing IT packages (including packages still under development) and/or aspects thereof in view of a set of roles of intended users. An IT “package”, as that term is used herein, may comprise one or more components, one or more products, tooling, or a complete solution.

The related invention titled “Assessing Information Technology Products” (Ser. No. 10/612,540) disclosed techniques for assessing information technology products, and more particularly disclosed techniques for comparing a product (including a product still under development) to a set of criteria, where the comparison is preferably directed toward ensuring, and/or improving, the product's acceptance by its target marketplace. However, it is desirable to assess other units of software packaging, such as components (as addressed, generally, in the related invention titled “Assessing Information Technology Components”, Ser. No. 10/______) or complete solutions. Accordingly, techniques disclosed in these related IT assessment applications are extended herein to address a different packaging and assessment scope.

Furthermore, many software packages include functional capability targeted to, or usable by, audience members having multiple roles. For example, a particular software package might contain one aspect directed toward a first target audience, such as software developers, and another aspect directed toward a second target audience, such as end users. Techniques of the related IT assessment applications focus on assessments from a single role or perspective (referred to herein as a “role” for ease of reference). When a software package being assessed includes functional capability intended for multiple roles, a single assessment and assessment score resulting therefrom may not adequately represent the multiple roles. Accordingly, techniques disclosed herein extend the teachings of the related IT assessment applications to address role-based package assessments.

It may happen that entire set of market requirements, criteria, attributes, and/or (if applicable) weights associated therewith for assessing a software product does not apply equally to all role-specific aspects of a software package. Accordingly, when assessing packages, and role-specific aspects of packages, it becomes advantageous to review the set of market requirements, criteria, attributes, and/or weights to ensure that assessments use a subset thereof that is appropriate for the particular scope of this assessment. Preferred embodiments therefore disclose identifying and selecting appropriate subsets, conducting assessments using the selected subsets, and generating assessment scores for packages and role-specific aspects thereof. (References herein to assessing packages may be construed generally as applying also to assessing role-specific aspects of packages.) By assessing a package in view of its intended audience, packages can be provided that improve market acceptance for a particular target role and/or target market. Furthermore, plans or designs for a package can be assessed using techniques disclosed herein.

The term “profile” is used herein to refer to a subset of the functional capability of the requirements, criteria, and so forth for a software package, as that subset pertains to a particular target audience. For example, a software developer profile might be applicable to a particular software package that provides a toolkit, and a network administrator profile might be applicable to that same software package (to address functionality, for example, whereby a software developer interacts with the toolkit to select from development capabilities it provides and a network administrator interacts with the toolkit to install, configure, and manage its use by a community of software developers).

As discussed earlier, the functional decomposition approach has drawbacks when creating software components by harvesting functionality from existing products. As one example, a drawback of the functional decomposition approach is that no consideration is generally given during the decomposition process as to how the harvested component(s) will ultimately be used, or to the results achieved from such use. In particular, functional decomposition does not focus on profiles applicable to an existing product or the roles of intended users of the product. When using functional decomposition to create components, a result may be creation of components that do not achieve their potential for reuse and/or that fail to satisfy requirements of their target market or target audience of users. Suppose a message logging capability is identified as a reusable component during functional decomposition, for example. If the code providing that message logging capability has a complicated user interface, then this code may be a poor choice for providing a message logging capability within an end-user-oriented aspect of a package. Techniques disclosed herein enable role-based assessments of packages, including components to be harvested or designed anew, thereby ensuring that the functional capability will meet the needs of its intended audience.

In addition, because it seeks to break down already-existing code into components, the functional decomposition approach does not seek to provide components that are designed specifically to satisfy particular market requirements or market requirements which may be of most importance in the target market.

As another example scenario where techniques disclosed herein may be used advantageously, a particular package might be comprised of a number of software products. Each product might be assessed using techniques disclosed in the related application entitled “Assessing Information Technology Products” (Ser. No. 10/612,540). However, such individual product assessments might not provide an accurate view of the ability of the overall package to meet the specific needs of users in roles to which the package will be targeted. Techniques disclosed herein facilitate ensuring that each package fulfills the appropriate requirements of its intended target market, for each unique role.

In preferred embodiments, the present invention provides techniques for assessing IT packages by comparing aspects of a package (including aspects of a package still under development) to a set of criteria. For example, when taking a role-based perspective, the aspect may comprise functional capabilities of the package that are directed toward a particular role. These measurement criteria are preferably designed to measure the aspect's success at addressing requirements of a target market, and each of these criteria has one or more attributes. The measurement criteria may be different in priority from one another, and may therefore be weighted such that varying importance of particular requirements to the target market can be reflected. In preferred embodiments, one or more assessment scores is created as a result of the comparison. When necessary, a set of recommendations for changing a package may also be created.

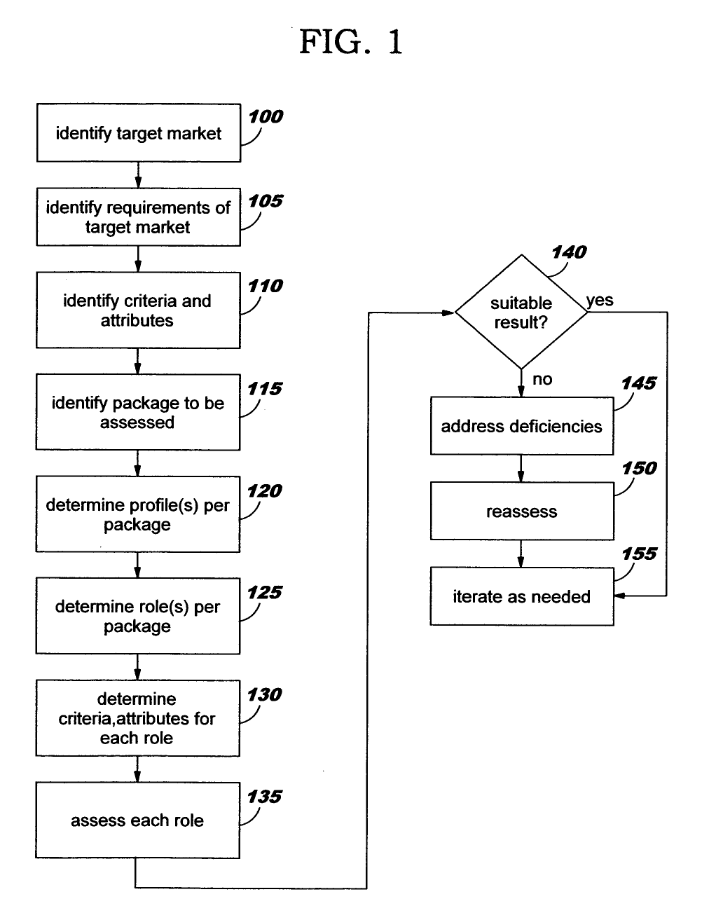

Referring now to FIG. 1, an overview is provided of a role-based package assessment approach according to preferred embodiments of the present invention. As shown therein at Block 100, a target market or market segment is identified. (The terms “target market” and “market segment” are used interchangeably herein.)

Requirements of the identified target market are also identified (Block 105). As discussed in the related applications, a number of factors may influence whether an IT product is successful with its target market, and these factors may vary among different segments of the market. Accordingly, the requirements that are important to the target market are used in assessing packages to be marketed therein.

Criteria of importance to the target market, and attributes for measurement thereof, are identified (Block 110) for use in the assessment process. Multiple attributes may be defined for any particular requirement, as deemed appropriate. High-potential attributes may also be identified. Objective means for measuring each criterion are preferably determined as well. Optionally, weights to be used with each criterion may also be determined.

As one example, if an identified requirement is “reasonable footprint”, then a measurement attribute may be defined such as “requires less than . . . [some amount of storage]”; or, if an identified requirement is “easy to learn and use”, then a measurement attribute may be defined such as “novice user can use functionality without reference to documentation”. Degrees of support for particular attributes may also be measured. For example, a measurement attribute of the “easy to learn and use” requirement might be specified as “novice user can successfully use X of 12 key functions on first attempt”, where the value of “X” may be expressed as “1-3”, “4-6”, “7-9”, and so forth.

Market segments may be structured in a number of ways. For example, a target market for an IT package may be segmented according to industry. As another example, a market may be segmented based upon company size, which may be measured in terms of the number of employees of the company. The manner in which a market is segmented does not form part of the present invention, and techniques disclosed herein are not limited to a particular type of market segmentation. Furthermore, the attributes of importance to a particular market segment may vary widely, and embodiments of the present invention are not limited to use with a particular set of attributes. Attributes discussed herein should therefore be construed as illustrating, but not limiting, use of techniques of the present invention.

The package to be assessed is identified (Block 115), and profiles that are applicable to that package are determined (Block 120) such that specialized requirements of the profile(s) can be assessed. Roles to be supported by the package are determined (Block 125), thereby enabling appropriate role-specific perspectives to be considered during the assessment process.

From the criteria and attributes that were previously determined as being of significance to the package (refer to the discussion of Block 110), Block 130 then selects out those of importance for each of the identified roles for this package. Adjustments and refinements may be made, as necessary. The means for measuring the criteria and/or the weights associated therewith may be adjusted, if needed, to provide assessment results that are better tailored to the roles. (As an alternative to the flow shown in FIG. 1, in an alternative approach, the identifications represented by Blocks 115-125 may be performed prior to the information gathering represented by Blocks 100-110, such that this information gathering is directly targeted to the roles supported by the package.)

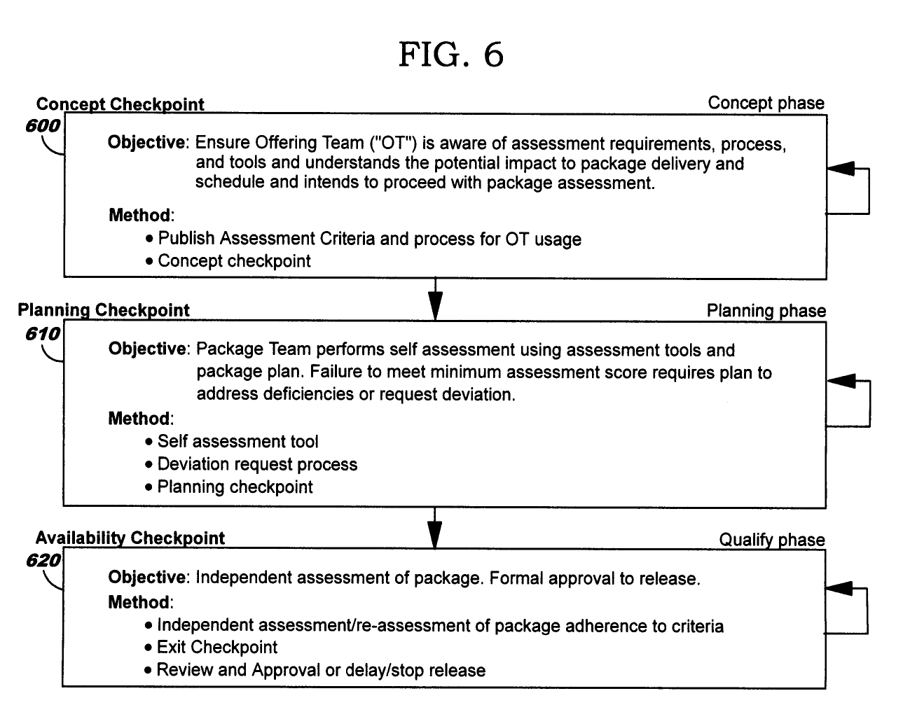

The role-based assessment is then conducted for each of the identified roles (Block 135). As noted earlier, the assessment may pertain to existing functionality or to plans and/or design specifications for developing such functionality. (Refer also to the discussion of FIG. 6, below, where this is described in more detail.)

Following Block 135, a test is made at Block 140 as to whether the assessment score indicates that this is a suitable result. This test preferably comprises comparing a numeric assessment score to a predetermined threshold. Assessment results, and how those results can be used to determine whether an assessment score is suitable, will be discussed in more detail below. When multiple roles have been assessed, the test at Block 140 is carried out with regard to the assessment score for each such role. If the test at Block 140 is negative, then deficiencies identified during the assessment process are addressed (Block 145). For example, it might be determined that the functionality for a particular role needs to be modified before the package aspect targeted for that role will be successfully received in the target market. Or, it might be determined that functionality yet to be developed needs redesign in selected areas.

Following Block 145, a reassessment is preferably conducted (Block 150). The operations depicted in FIG. 1 may then iterate, as needed, as indicated in Block 155. For example, functionality might be assessed for additional roles, and/or other packages might be assessed.

Assessing packages and roles thereof, using the approach shown in FIG. 1 and described herein, improves the likelihood that the package will meet requirements of a particular target market. When assessing a package (or aspects thereof) not yet developed, the assessment process described herein can be used to ensure that features are included that will support requirements which have been identified for the target market. Furthermore, assessing package aspects for a particular role individually (rather than as part of the overall package) enables identifying characteristics of the aspect that need improvement for that particular role, which in turn allows such characteristics to be addressed and resolved prior to releasing the package to the target market.

Techniques of the present invention are described herein with reference to particular criteria and attributes developed to assess software packages with reference to requirements that have been identified for a hypothetical target market, as well as with reference to assessment scores that are expressed as a numeric value. However, it should be noted that these descriptions are by way of illustrating use of the novel techniques of the present invention, and should not be construed as limiting the present invention to these examples. In particular, alternative target markets, alternative criteria and attributes, and alternative techniques for computing and expressing a result of the assessment process may be used without deviating from the scope of the present invention.

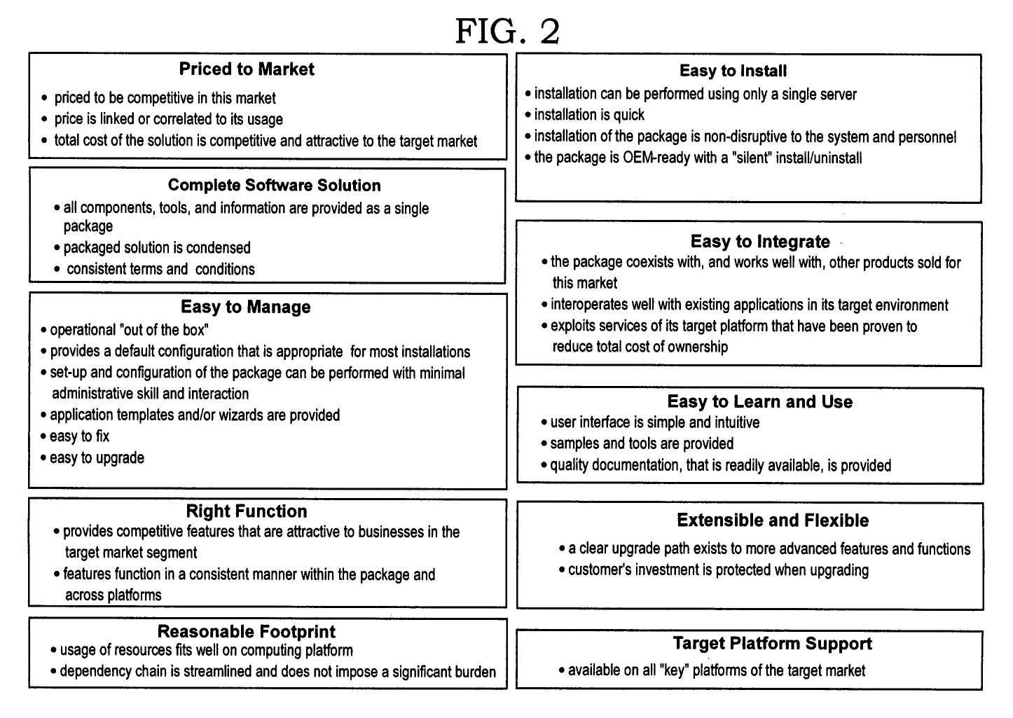

FIG. 2 provides a chart summarizing a number of criteria and attributes pertaining to market requirements, by way of example. These criteria and attributes will now be described in more detail. (Note that when conducting role-specific assessments, these criteria and attributes may be adjusted to those specific roles, as has been discussed above.)

Priced to Market. This criterion is directed toward determining how well the assessed package is priced for its target market. Attributes for this comparison include: (i) whether the package is priced to be competitive in this market; (ii) whether the price is linked or correlated to its usage (e.g., in terms of the number of users or the number of processors on which it will be installed); and (iii) whether the total cost of the solution is competitive and attractive to the target market.

Complete Software Solution. This criterion judges whether the package provides a complete software solution for its users. Attributes may include: (i) whether all components, tools, and information needed for successfully implementing the solution are provided as a single package; (ii) whether the packaged solution is condensed—that is, providing only the required function; and (iii) whether the packaged solution has consistent terms and conditions (sometimes referred to as “T's and C's”).

Easy to Manage. This criterion measures how easy the package is to manage or administer. Attributes defined for this criterion may include: (i) whether the package is operational “out of the box” (e.g., as delivered to the customer); (ii) whether the package, as delivered, provides a default configuration that is appropriate for most installations; (iii) whether the set-up and configuration of the package can be performed with minimal administrative skill and interaction; (iv) whether application templates and/or wizards are provided to simplify use of the package and its more complex tasks; (v) whether the package is easy to fix if defects are found; and (vi) whether the package is easy to upgrade.

Right Function. The assessment process also preferably measures whether the assessed package includes the “right” function. Attributes for making this decision include: (i) whether the package provides competitive features that are attractive to businesses in the target market segment; and (ii) whether the provided features function in a consistent manner within the package and across platforms.

Reasonable Footprint. For many IT markets, the availability of computing resources such as storage space and memory usage is considered to be important, and thus a criterion that may be used in assessing packages is whether the package has a reasonable footprint. Attributes may include: (i) whether the package's usage of resources such as random-access memory (“RAM”), central processing unit (“CPU”) capacity, and persistent storage (such as disk space) fits well on a computing platform used in the target environment; and (ii) whether the package's dependency chain is streamlined and does not impose a significant burden.

Easy to Install. This criterion measures how easily the package is installed in its intended market. Attributes used for this measurement may include: (i) whether the installation can be performed using only a single server; (ii) whether installation is quick (e.g., measurable in minutes, not hours); (iii) whether installation is non-disruptive to the system and personnel; and (iv) whether the package is OEM-ready with a “silent” install/uninstall (that is, whether the package includes functionality for installing and uninstalling itself without manual intervention).

Easy to Integrate. This criterion is used to measure how easy it is to integrate the package in its target environment Attributes used in this comparison may include: (i) whether the package coexists with, and works well with, other products sold for this market; (ii) whether the package interoperates well with existing applications in its target environment; and (iii) whether the package exploits services of its target platform that have been proven to reduce total cost of ownership.

Easy to Learn and Use. Another criterion preferably measured is how easy it is to learn and use the assessed package. Attributes for this measurement may include: (i) whether the package's user interface is simple and intuitive; (ii) whether samples and tools are provided, in order to facilitate a quick and successful first-use experience; and (iii) whether quality documentation, that is readily available, is provided.

Extensible and Flexible. Another criterion preferably used in the assessment is the package's extensibility and flexibility. Attributes used for this measurement may include: (i) whether a clear upgrade path exists to more advanced features and functions; and (ii) whether the customer's investment is protected when upgrading.

Target Market Platform Support. Finally, another criterion used when assessing packages for the target market may be platform support. An attribute used for this purpose may be whether the package is available on all “key” platforms of the target market. Priority may be given to selected platforms.

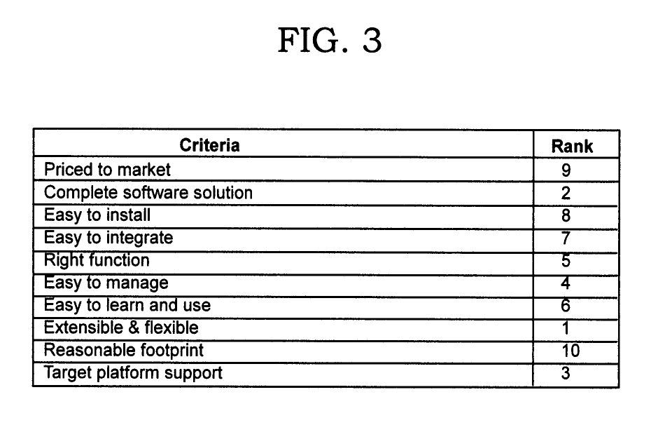

The particular criteria to be used for a package assessment, and attributes used for those criteria, are preferably determined by market research that analyzes what factors are significant to people making IT purchasing decisions. Preferred embodiments of the assessment process disclosed herein use these criteria and attributes as a framework for evaluating packages and aspects thereof. Profiles may be specified with regard to this information, as discussed above with reference to Block 120 of FIG. 1. The market research preferably also includes an analysis of how important the various factors are in the purchasing decision. Therefore, preferred embodiments of the present invention allow weights to be assigned to attributes and/or criteria, enabling them to have a variable influence on an assessment score. These weights preferably reflect the importance of the corresponding attribute/criteria to the target market. Accordingly, FIG. 3 provides sample rankings with reference to the criteria in FIG. 2, showing the relative importance of these factors for IT purchasers in a hypothetical market segment.

It should be noted that the attributes and criteria that are important to IT purchasing decisions may change over time. In addition, the relative importance thereof may change. Therefore, embodiments of the present invention preferably provide flexibility in the assessment process and, in particular, in the attributes and criteria that are measured, in how the measurements are weighted, and/or in how an assessment score is calculated using this information.

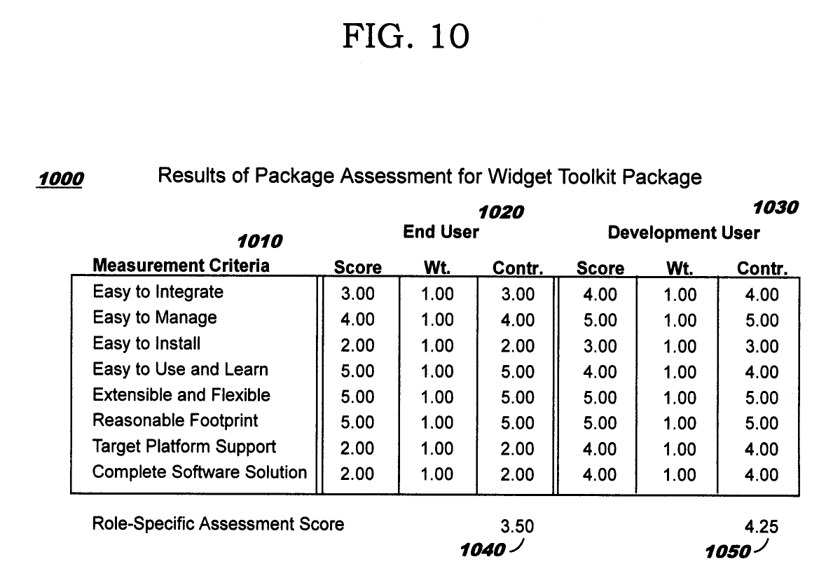

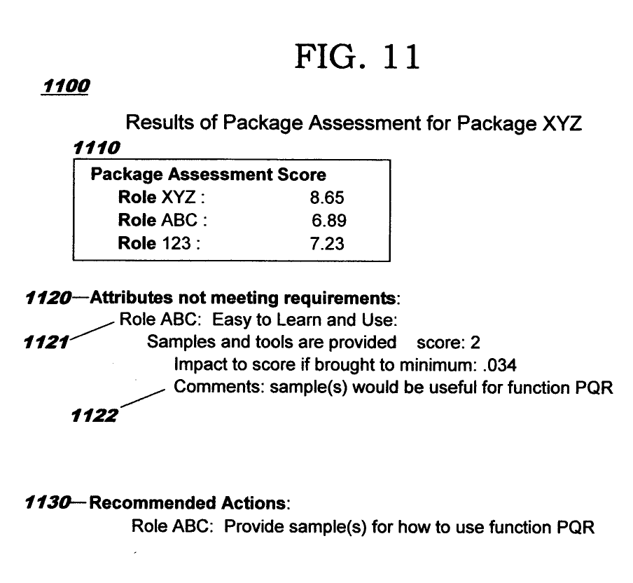

By using the framework of the present invention with its well-defined and objective measurement criteria and attributes, and its objective checkpoints, the assessment process can be used advantageously to guide and focus package development efforts for creating packages intended for a target market. (This will be described in more detail below. See, for example, the discussion of FIG. 10, which presents a sample assessment report that may be used to predict how well a package will meet role-specific requirements in its target market.)

Preferably, numeric values such as a scale of 1 to 5 are used when measuring each of the attributes during the assessment process. In this manner, relative degrees of support (or non-support) can be indicated. (Alternatively, another scale, such as 0 to 5, might be used.) In the examples used herein, a value of 5 indicates the best case, and 1 represents the worst case. In preferred embodiments, textual descriptions are provided for each numeric value of each attribute. These textual descriptions are designed to assist package assessors in performing an objective, rather than subjective, assessment Preferably, the textual descriptions are defined so that a package aspect being assessed will receive a score of 3 on an attribute if the aspect meets the market's expectation for that attribute, a score of 4 if the aspect exceeds expectations, and a score of 5 if the aspect greatly exceeds expectations or sets new precedent for how the attribute is reflected in the package. On the other hand, the descriptions are preferably defined so that an aspect that meets some expectations for an attribute (but fails to completely meet expectations) will receive a score of 2 for that attribute, and an aspect that obviously fails to meet expectations for the attribute (or is considered obsolete with reference to the attribute) will receive a score of 1.

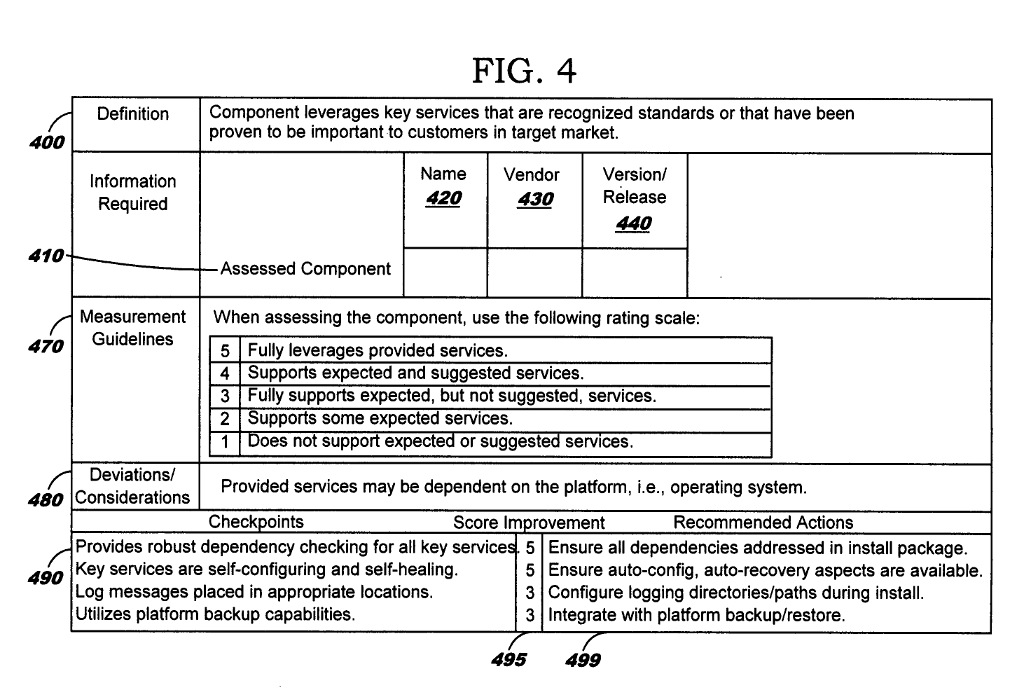

FIG. 4 provides an example of the textual descriptions that may be used to assign a value to the “exploits services of its target platform that have been proven to reduce total cost of ownership” attribute of the “Easy to Integrate” criterion that was stated above, and is representative of an entry from an evaluation form or workbook that may be used during an assessment. As illustrated in FIG. 4, a definition 400 is preferably provided to explain the intent of this attribute to the package assessment team. (The information illustrated in FIG. 4 may be used during a package assessment carried out by a package assessment team, and/or by a package development team that wishes to determine how well its package will be assessed.)

A package name and vendor (see elements 420, 430) may be specified, along with version and release information (see element 440) or other information that identifies the particular package under assessment. A role to which this assessment pertains may also be specified (see element 450).

A set of measurement guidelines (see element 470) is preferably provided as textual descriptions for use by the package assessors. In the example, a value of 3 is assigned to this attribute if the package fully supports a set of “expected” services, but fails to support all “suggested” services. A value of 5 is assigned if the assessed package fully leverages all of the provided (i.e., expected as well as suggested) services, whereas a value of 1 is assigned if the package fails to support the expected services and the suggested services. If the assessed package supports (but does not fully leverage) expected and suggested services, then a value of 4 is assigned. And, if the assessed package supports some of the expected services, then a value of 2 is assigned. (What constitutes an “expected service” and a “suggested service” may vary widely from one package to another and/or from one target market to another.)

Element 480 indicates that an optional feature of preferred embodiments allows per-attribute deviations when assigning values to attributes for the assessed package. In this example, the deviation information explains that the provided services may be dependent on the platform(s) on which this package will be used.

One or more checkpoints and corresponding recommended actions may also be provided. See elements 490 and 499, respectively, where sample checkpoints and actions have been provided for this attribute. In addition, a set of values may be specified to indicate how providing each of these will impact or improve the component's assessment score. See element 495, where sample values have been provided. (The information shown at 490-499 may be used, for example, when developing prescriptive statements of the type discussed with reference to Block 115 of FIG. 1 in the component design application.)

Information similar to that depicted in FIG. 4 is preferably created for measurement guidelines to be used by package assessors when assessing each of the remaining attributes.

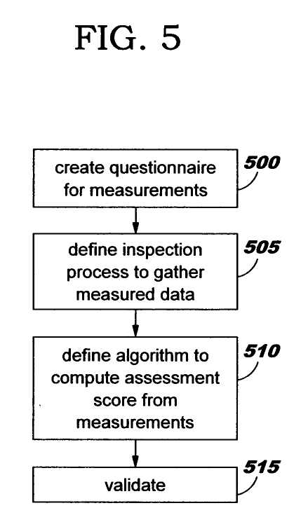

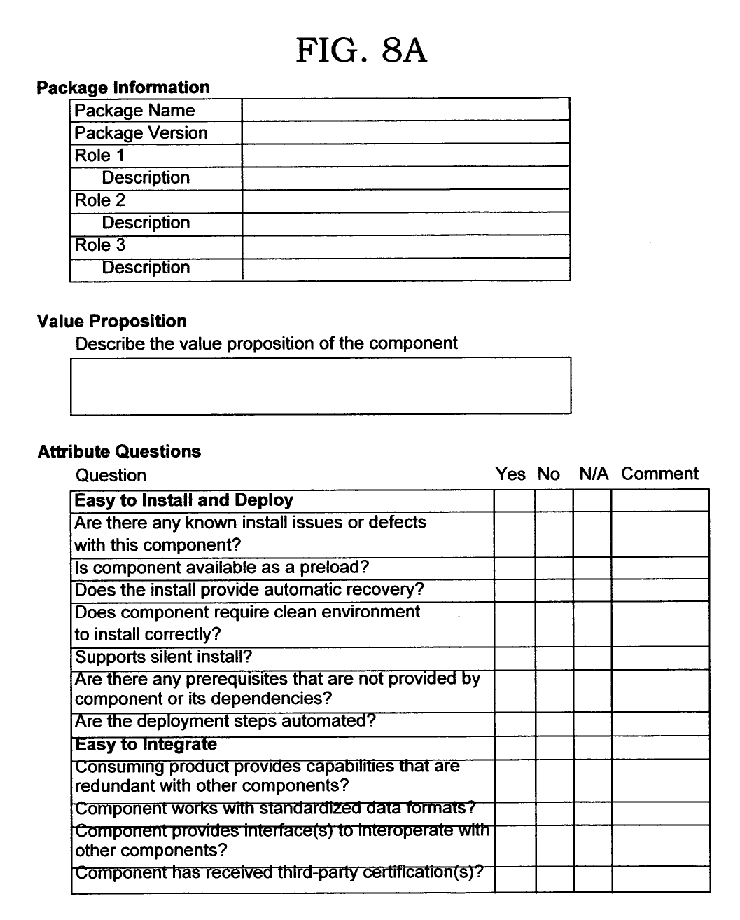

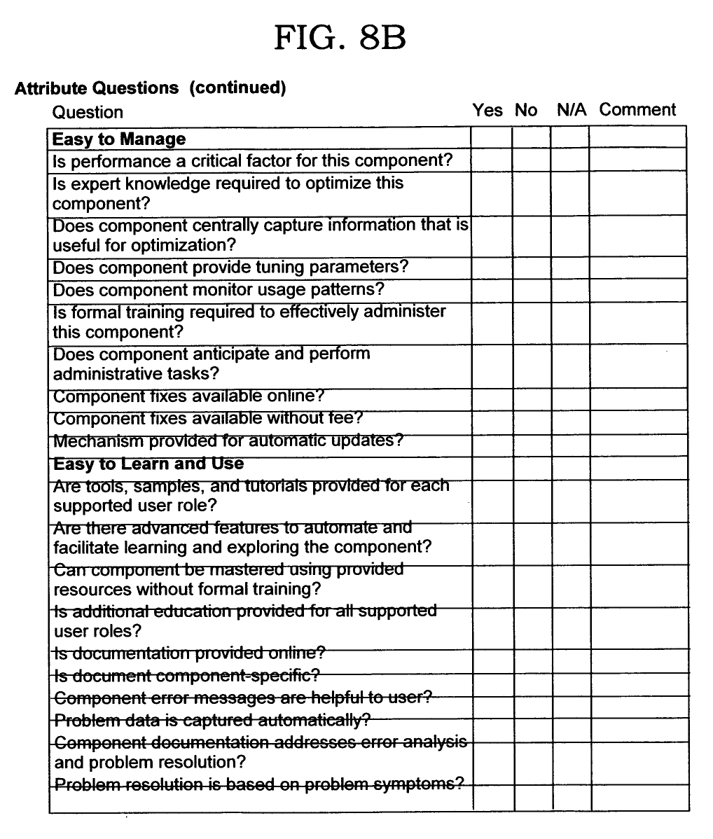

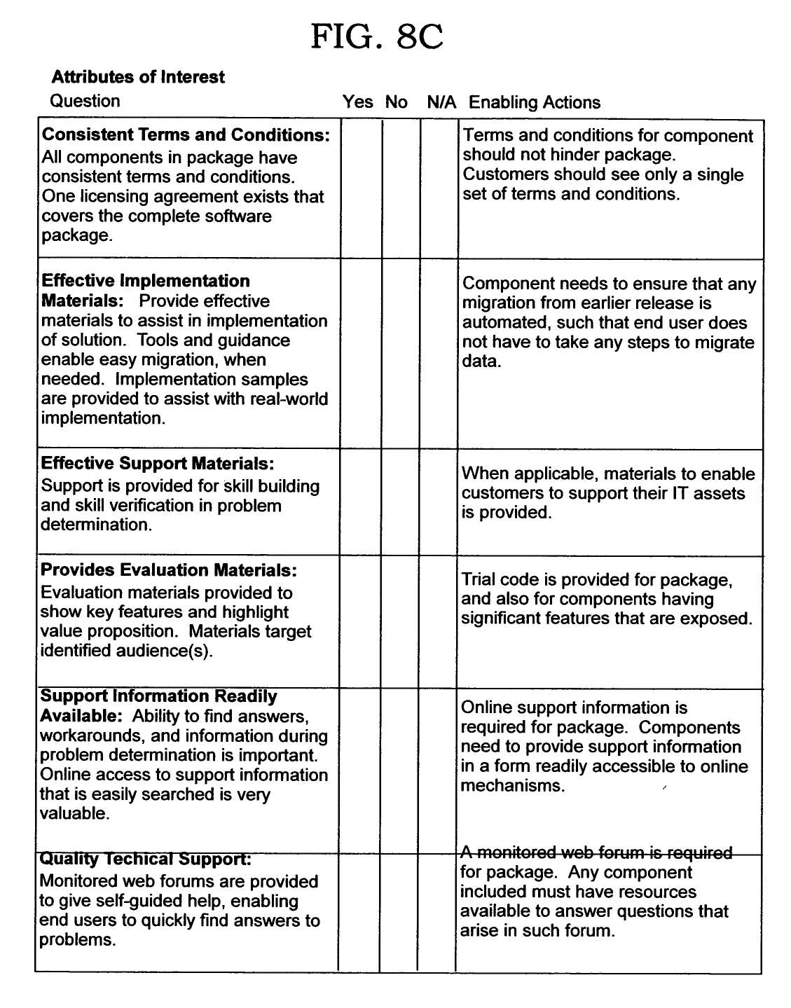

Referring now to FIG. 5, a flowchart is provided illustrating, at a high level, actions that are preferably carried out when establishing an assessment process according to the present invention. At Block 500, a questionnaire is preferably developed for use when gathering assessment data. Preferred embodiments of the present invention use an initial written or electronic questionnaire to solicit information from the package team. See FIG. 8 for an example of a questionnaire that may be used for this purpose. An inspection process is preferably defined (Block 505), where this inspection process is to be used for information-gathering as part of the assessment. This inspection is preferably an independent evaluation, performed by a package assessment team that is separate and distinct from the package development team, during which further details and measurement data will be gathered.

An algorithm or computational steps are preferably developed (Block 510) to use the measurement data for computing an assessment score for assessed packages and roles. This algorithm may be embodied in a spread sheet or other automated technique.

One or more trial assessments may then be conducted (Block 515) for validation. For example, one or more existing packages or roles may be assessed, and the results thereof may be analyzed to determine whether an appropriate set of criteria, attributes, priorities, and deviations has been put in place. If necessary, adjustments may be made, and the process of FIG. 5 may be repeated in view of these adjustments. (Refer also to FIG. 1, which describes assessing packages using an assessment process that may be established according to FIG. 5.)

A package assessment as disclosed herein may be performed in an iterative manner. This is illustrated in FIG. 6. Accordingly, assessments or assessment-related activities may be carried out at various checkpoints (referred to equivalently herein as “plan checkpoints”) during a package's development. First, as shown at element 600, assessment activities may be carried out while a package is still in the concept phase (i.e., at a concept checkpoint). In preferred embodiments, this comprises ensuring that the offering team (“OT”) is aware of the criteria and attributes that will be used to assess the package, as well as informing them about the manner in which the assessment will be performed and its impact on their delivery and scheduling requirements. This provides a prescriptive approach to package development, whereby the package developers may be provided with a list or set of market-specific goals such as “package will score a ‘5’ on ‘Easy to Learn and Use’ criterion if: (1) samples are provided for all exposed end-user functions; (2) all key functions can be learned by novice user within 2 attempts; . . . ”. (Prescriptive statements are described in more detail in the component design application.)

When the package reaches the planning checkpoint, plan information is preferably used to conduct an initial assessment. This initial assessment is preferably conducted by the package development team, as a self-assessment, using the same criteria and attributes (and the same textual descriptions of how values will be assigned) as will be used by the package assessment team later on. See element 610. The package development team preferably uses its package development plans (e.g., the planned package features) as a basis for this self-assessment. Performing an assessment while an IT component is still in the planning phase may prove valuable for guiding a package development plan. Package features can be selected from among a set of candidates, and the subsequent development effort can then focus its efforts, in view of how this package (plan) assessment indicates that the wants and needs of the target market will be met.

As stated earlier, a package assessment score is preferably expressed as a numeric value. A minimum value for an acceptable score is preferably defined, and if the self-assessment at the planning checkpoint is lower than this minimum value, then in preferred embodiments, the package development team is required to revise its package development plan to raise the package's score and/or to request a deviation for one or more low-scoring attributes. Optionally, approval of the revised plan or a deviation request may be required.

Another assessment is then preferably performed during the development phase, as the package nears the end of the development phase (e.g., prior to releasing the package to its target market). This is illustrated in FIG. 6 by the availability checkpoint (see element 620), and a suitable score during this assessment may be required as an exit checkpoint before the package qualifies for release to the market. Preferably, this assessment is carried out by an independent team of package assessors, as discussed earlier. At this phase, the assessment is performed using the developed package and its associated information (e.g., documentation, related tools, and so forth). According to preferred embodiments, if deficiencies are found in the assessed package, then recommendations are provided and the package is revised. Therefore, it may be necessary to repeat the independent assessment more than once.

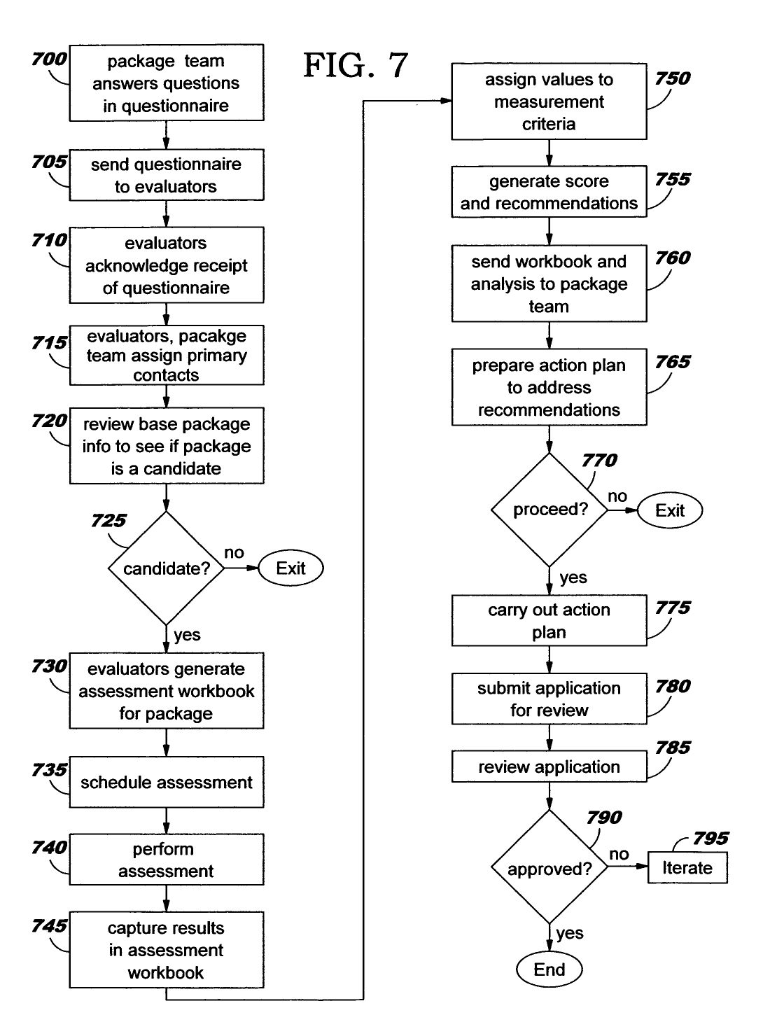

FIG. 7 provides a flowchart depicting, in more detail, how a package assessment may be carried out. The package team (e.g., planning team or development team, as appropriate) answers the questions on the assessment questionnaire that has been created (Block 700), and then submits this questionnaire (Block 705) to the assessors or evaluators. (FIG. 8 provides a sample questionnaire.) Optionally, the evaluators may acknowledge (Block 710) receipt of the questionnaire, and primary contact information may be exchanged (Block 715) between the package team and the evaluators.

The evaluators may optionally perform a review of basic package information (Block 720) to determine whether this package is a candidate for undergoing the assessment process. Depending on the outcome (Block 725), then the flow shown in FIG. 7 may exit (if the package is determined not to be a candidate) or it may continue at Block 730.

When Block 730 is reached, then this package is a candidate, and the evaluators preferably generate what is referred to herein as an “assessment workbook” for the package. The assessment workbook provides a centralized place for recording information about the package, and when assessments are performed during multiple phases (as discussed above), preferably includes the assessment information from each of the multiple assessments for the package. Furthermore, when multiple roles for a package are assessed, the assessment workbook preferably includes recorded information from all of these role-specific assessments. Items that may be recorded in the assessment workbook include planning information, competitive positioning of competing packages, comparative data for predecessor versions of a package, inspection findings, and/or assessment calculations.

At Block 730, the assessment workbook is preferably populated (i.e., updated) with initial information taken from the questionnaire that was submitted by the package team at Block 700. Note that some of the information on the questionnaire may directly generate measurement data, while for other information, further details are required from the actual package assessment. For example, the target platform service exploitation information discussed above with reference to FIG. 4 (including measurement guidelines 470) could be included on a package questionnaire, and answers from the questionnaire could then be used to assign a value from 1 to 5. For measurements related to installation or execution, such as how long it takes a novice user to learn a package's key functions, the questionnaire answers are not sufficient, and thus values for these measurements will be supplied later (e.g., during the inspection).

A package assessment is preferably scheduled (Block 735), and is subsequently carried out (Block 740). Performing the assessment preferably comprises conducting an inspection of the package, when carried out during the development phase, or of the package development plan, when carried out in the planning phase. When the operational package (or an interim version thereof) is available, this inspection preferably includes simulating a “first-use” experience, whereby an independent team or party (i.e., someone other than a development team member) receives the package in a manner similar to its intended delivery (for example, as some number of CD-ROMs, other storage media, or download instructions, and so forth) and then begins to use the functions of the package. (Note that when an assessment is performed using an interim version of a package, the scores that are assigned for the various attributes preferably consider any differences that will exist between the interim version and the final version, to the extent that such differences are known. Preferably, the package planning/development team provides detailed information on such differences to the package assessment team. If no operational code is available, then the inspection may be performed by review of code or similar documentation.)

Results of the inspection are captured (Block 745) in the assessment workbook. Values are assigned for each of the measurement attributes (Block 750), and these values are recorded in the assessment workbook. As discussed earlier, these values are preferably selected from a numeric range, such as 1 to 5, and textual descriptions are preferably defined in advance to assist the assessors in consistently applying the measurements to achieve an objective assessment score.

Once the inspection has been completed and values are assigned and recorded for all of the measurement attributes, a package assessment score is generated (Block 755) for each assessed role. The manner in which the score is computed, given the gathered information, may vary widely. One or more recommendations may also be generated, depending on how the package scores on particular attributes, to inform the package team where changes should be made to improve the package's score (and therefore, to improve factors such as acceptance of the package by its target market).

According to preferred embodiments, any measurement attribute for which the assigned value is 1 or 2 requires follow-up action by the package team, as these are not considered acceptable values. Thus, attributes receiving these values are preferably flagged or otherwise indicated in the assessment workbook. Preferred embodiments also require an overall score of at least 7 on a scale of 0 to 10, and any package aspect scoring lower than 7 requires review of its assessment attributes and improvement before being approved for release. (Overall scores and minimum required scores may be expressed in other ways, such as by using percentages values, without deviating from the scope of the present invention.) Optionally, selected attributes may be designated as critical or imperative for acceptance of this aspect's functionality in the target marketplace. In this case, even though a package's overall assessment score exceeds the minimum acceptable value, if it scores a 1 or 2 on a critical attribute, then review and improvement is required on these scores before the package can be approved.

When weights have been assigned to the various measurement attributes, then these weights may be used to prioritize the recommendations that result from the assessment. In this manner, actions that will result in the biggest improvement in the assessment score can be addressed first.

The assessment workbook and analysis is then sent to the package team (Block 760) for their review. The package team then prepares an action plan (Block 765), as necessary, to address each of the recommendations. A meeting between the package assessors and representatives of the package team may be held to discuss the findings in the assessment workbook and/or the recommendations. The action plan may be prepared thereafter. Preferably, the actions from this action plan are recorded in the assessment workbook.

At Block 770, a test is made as to whether this package (or package plan) should proceed. If not (for example, if the package assessment score is too low, and sufficient improvements do not appear likely or cost-effective), then the process of FIG. 7 is exited. Otherwise, as shown at Block 775, the action plan is carried out. For example, if the package is still in the planning phase, then Block 775 may comprise selecting different features to be included in the package and/or redefining the existing features. If the package is in the development phase, then Block 775 may comprise redesigning function, revising documentation, and so forth, depending on where low attribute scores were assigned.

Block 780 indicates that, when the package's action plan has been carried out, an application for package approval may be submitted. This application is then reviewed (Block 785) by the appropriate person(s), who is/are preferably distinct from the assessment team, and if approved (i.e., the test at Block 790 has a positive result), then the process of FIG. 7 is complete. Otherwise, if Block 790 has a negative result, then the package's application is not approved (for example, because the package's assessment score is still too low, or the low-scoring attributes are not sufficiently improved, or because this is an interim assessment), and the process of FIG. 7 iterates, as shown at Block 795.

Optionally, a special designation may be granted to the package or aspect(s) thereof when the test in Block 790 has a positive result. This designation may be used, for example, to indicate that this package or aspect has achieved at least some predetermined assessment score with regard to the assessment criteria, which may be used as a distinguishing feature of the package. A package or aspect that fails to meet this predetermined assessment score may still be released for reuse, but without the special designation. Furthermore, the test performed at Block 725 of FIG. 7 may be made with reference to whether the package's basic information indicates that this package is a candidate for receiving the special designation, and the decisions made at Block 770 and 790 may be made with reference to whether this package remains a candidate for, and should receive, respectively, the special designation.

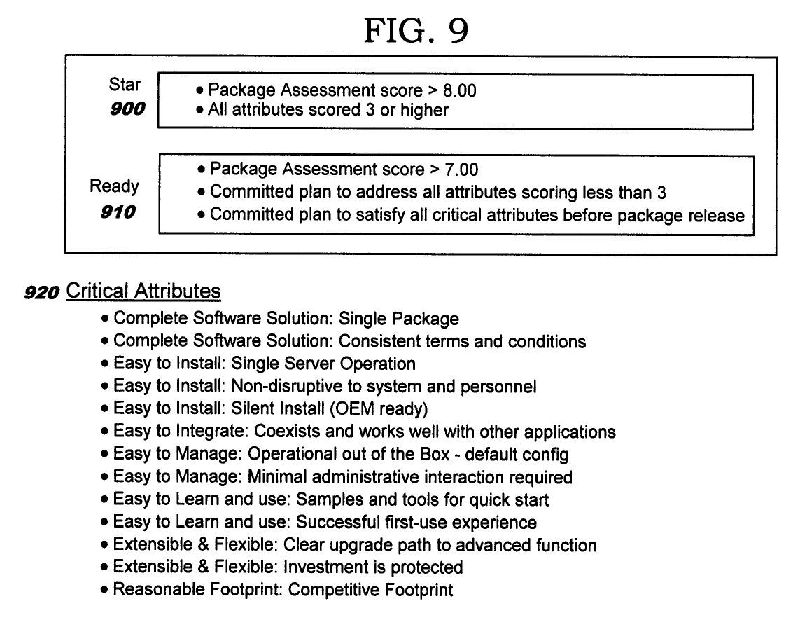

As stated earlier, a minimum acceptable assessment score is preferably specified for packages to be assessed using the package assessment process. In addition to using this minimum score for determining when an assessed package is required either (i) to make changes and undergo a subsequent assessment and/or (ii) to justify its deviations, the minimum score may be used as a gating factor for receiving the special designation discussed above. Referring now to FIG. 9, an example is provided that illustrates how two different scores may be used for determining whether a package is ready for release and whether a package or aspect will receive a special designation. As shown therein (see element 900), a package may be designated as “star” if its overall package assessment score exceeds 8.00 (or some other appropriate score) and each of the assessed attributes has been assigned a value of 3 or higher on the 5-point scale. Or, the package may be designated as “ready” (see element 910) if the following criteria are met: (1) its overall package assessment score exceeds 7.00; (2) a committed plan has been developed that addresses all attributes scoring lower than 3 on the 5-point scale; and (3) a committed plan is in place to satisfy, before release of the package, all attributes that have been determined to be “critical”. In this example, the “ready” designation indicates that the package has scored high enough to be released, whereas the “star” designation indicates that the package has also scored high enough to receive this special designation. (Alternative criteria for assigning a special designation to a package may be defined, according to the needs of a particular environment in which the techniques disclosed herein are used.) A similar approach may be taken to determine whether one or more role-specific aspects of a package can receive a special designation.

Element 920 provides a sample list of criteria and attributes that have been identified as critical. (In this example, not all of the measurement criteria from FIG. 2 are represented.) For the 7 listed criteria, 13 different attributes are identified as critical. By comparing the list at 920 to the attributes identified in FIG. 2, it can be seen that there are a number of attributes that are considered important for measuring, but that are not considered to be critical. Preferably, the identification of critical attributes is substantiated with market intelligence or consumer feedback. This list may be revised over time, as necessary, to keep pace with changes in that information. When weights are assigned to attributes for computing a package's assessment score, as discussed above, a relatively higher weight is preferably assigned to the attributes appearing on the critical attributes list.

FIG. 10 shows a sample package assessment report 1000 where two roles 1020, 1030 of a hypothetical “Widget Toolkit Package” have been assessed and scored. Preferably, a report is prepared after each assessment, and provides information that has been captured in the assessment workbook A “measurement criteria” column 1010 lists criteria which were measured, and in this example, the criteria are provided in a summarized form. (As an alternative, a report may be provided that gives details of each individual attribute measured for each of the criteria.)

For each assessed role, the assessment report indicates how that role scored for each of the criteria (see the “Score” columns), the weight assigned to prioritize that criterion (see the “Wt.” columns), and the contribution that this weighted criterion assessment makes to the overall assessment score for this role (see the “Contr.” columns). In preferred embodiments, an algorithm is then used to produce the role-specific assessment scores from the weighted criteria contributions. In this example, the “End User” role 1020 has an assessment score of 3.50 (see 1040) and the “Development User” role 1030 has an assessment score of 4.25 (see 1050). Note that the sample report in FIG. 10 uses identical weights for each of the measurement criteria in each of the roles. This is by way of illustration only, and in preferred embodiments, variable weights are supported to enable the computed assessment scores to reflect importance of each of the criteria in each role.

FIG. 11 shows a sample summary report 1100 providing an example of summarized assessment results for an assessed package named “Package XYZ”. As shown at element 1110, the package's assessment results are provided as assessment scores for three roles that pertain to this package. In the example, these roles are identified as “Role XYZ”, “Role ABC”, and “Role 123”. Using the role-specific measurement criteria and attributes, these roles received scores of 8.65, 6.89, and 7.23, respectively. Thus, the package team may be provided with an at-a-glance view of how well the roles supported by their package meet requirements of the target market(s) and audience(s) thereof. This allows the package team to determine how well their package will be received, and when the score is lower than the required minimum, to gauge the amount of rework that will be necessary before the package should be released to the market.

Optionally, an overall package score may also be computed and provided in the summary assessment report 1100, although this has not been illustrated in FIG. 11.

A summary 1120 is also provided, listing each of the attributes that did not achieve the minimum acceptable score (which, in preferred embodiments, is a 3 on the 5-point scale, as stated above). In this example, one attribute of the “Easy to Learn and Use” criterion (see 1121) failed to meet this minimum score for the role identified as “Role ABC”. In the example report, the actual score assigned to the failing attribute is presented, along with an impact value and comments. The impact value indicates, for each failing attribute, how much of an improvement to the role-specific assessment score would be realized if this attribute's score was raised to the minimum score of 3. For each attribute in this summary 1120, the assessment team preferably provides comments that explain why the particular attribute value was assigned. Thus, as shown in this example (see 1122), an improvement of 0.034 could be realized in the assessment score for Role ABC (from a score of “2”) if samples were provided for some function “PQR”.

A recommended actions summary 1130 is also provided, according to preferred embodiments, notifying the package team as to the assessment team's recommendations for improving the package's score. In this example, a recommended action has been provided for the attribute 1121 that did not meet requirements.

Preferably, the attributes in summary 1120 and the corresponding actions in summary 1130 are listed in decreasing order of potential improvement in the assessment score. This prioritized ranking is beneficial to the package development team, as it allows them to prioritize their efforts for revising the package or package aspect in view of where the most significant gains can be made in the assessment score. (Preferably, attribute weights are used in determining the impact values shown for each attribute in summary 1120, and these impact values are then used for the prioritization.)

Additionally, more-detailed information may also be included in assessment reports, although this detail has not been shown in the sample report 1100. Preferably, the summary information shown in FIG. 11 is accompanied by a complete listing of all attributes that were measured, the measurement values assigned to those attributes, and any comments provided by the assessment team (which may be in a form such as sample report 1000 of FIG. 10). If this package has previously undergone an assessment and is being reassessed as to improvements that have been made, then the earlier measurement values are also preferably provided. Optionally, where critical attributes have been defined, these attributes may be visually highlighted in the report.

As has been demonstrated, the present invention defines advantageous techniques for assessing IT packages and aspects thereof. Importance of various attributes to the target market are reflected in the assessments, and assessment results may then be provided to package teams to influence package planning and/or development efforts.

As will be appreciated by one of skill in the art, embodiments of the present invention may be provided as methods, systems, or computer program products comprising computer-readable program code. Accordingly, the present invention may take the form of an entirely hardware embodiment, an entirely software embodiment, or an embodiment combining software and hardware aspects. The computer program products maybe embodied on one or more computer-usable storage media (including, but not limited to, disk storage, CD-ROM, optical storage, and so forth) having computer-readable program code embodied therein.

When implemented by computer-readable program code, the instructions contained therein may be provided to a processor of a general purpose computer, special purpose computer, embedded processor, or other programmable data processing apparatus to produce a machine, such that the instructions, which execute via the processor of the computer or other programmable data processing apparatus, create means for implementing embodiments of the present invention.

These computer-readable program code instructions may also be stored in a computer-readable memory that can direct a computer or other programmable data processing apparatus to function in a particular manner, such that the instructions stored in the computer-readable memory produce an article of manufacture including instruction means which implement embodiments of the present invention.

The computer-readable program code instructions may also be loaded onto a computer or other programmable data processing apparatus to cause a series of operational steps to be performed on the computer or other programmable apparatus to produce a computer-implemented method such that the instructions which execute on the computer or other programmable apparatus provide steps for implementing embodiments of the present invention.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

1. A method of assessing information technology (“IT”) packages, comprising steps of:
determining a plurality of criteria that are important to a target market, and at least one attribute to be used for measuring each of the criteria;
specifying objective measurements for each of the attributes;
adapting the criteria, attributes, and measurements for each of one or more roles supported by an IT package to be assessed; and
conducting an evaluation of the IT package, further comprising steps of:
inspecting a representation of the IT package, with reference to selected ones of the adapted attributes for each of the roles;
assigning attribute values to the selected attributes, according to how the IT package compares to the adapted objective measurements for each of the roles;
generating an assessment score, for each of the roles, from the assigned attribute values; and
generating a list of recommended actions for each of the roles, the list having an entry for each of the selected attributes for which the assigned attribute value falls below a threshold, each of the entries providing at least one suggestion for improving the assigned attribute value.

2. The method according to claim 1, wherein the list of recommended actions is generated automatically, responsive to the assigned attribute values that fall below the threshold.

3. The method according to claim 1, further comprising the steps of:
prioritizing each of the adapted attributes in view of its importance to the target market;
assigning weights to the adapted attributes according to the prioritizations; and
using the assigned weights when generating the assessment score.

4. The method according to claim 1, wherein the assessment score is programmatically generated.

5. The method according to claim 1, wherein the step of conducting an evaluation is repeated at a plurality of plan checkpoints used in developing the IT package.

6. The method according to claim 5, wherein successful completion of each of the plan checkpoints requires the assessment score to exceed a predetermined threshold.

7. The method according to claim 1, wherein a package team developing the IT package provides input for the evaluation by answering questions on a questionnaire that reflects the attributes.

8. The method according to claim 1, wherein the assigned attribute values, the assessment score, and the list of recommended actions for each of the roles are recorded in a workbook.

9. The method according to claim 8, wherein the workbook is an electronic workbook.

10. The method according to claim 1, wherein a package team developing the IT package provides input for the evaluation by answering questions on a questionnaire that reflects the attributes, and wherein the answers to the questions, the assigned attribute values, the assessment score, and the list of recommended actions for each of the roles are recorded in an electronic workbook.

11. The method according to claim 1, further comprising the steps of providing the assigned attribute values, the assessment score, and the list of recommended actions for each of the roles to a package team developing the IT package.

12. The method according to claim 8, further comprising the step of providing the assessment workbook, following the evaluation, to the package development team.

13. The method according to claim 1, further comprising the step of assigning a special designation to the IT package, and/or to role-specific aspects thereof, if and only if the assessment scores for the roles exceed a predefined threshold.

14. A method of assessing an information technology (“IT”) package, comprising steps of:
determining a plurality of criteria for measuring role-specific aspects of an IT package, and at least one attribute that may be used for measuring each of the criteria;
specifying objective measurements for each of the attributes; and
conducting an evaluation of each of the role-specific aspects of the IT package, further comprising steps of:
inspecting a representation of the IT package, with reference to selected ones of the attributes for each of the role-specific aspects;
assigning attribute values to the selected attributes, according to how the IT package compares to the specified objective measurements for each of the role-specific aspects; and
generating an assessment score, for each of the role-specific aspects of the IT component, from the assigned attribute values.

15. The method according to claim 14, wherein the step of conducting the evaluation further comprises the step of generating a list of recommended actions for improving at least one of the role-specific aspects of the IT package.

16. The method according to claim 15, wherein the list has an entry for each of the selected attributes for which the assigned attribute value falls below a predetermined threshold.

17. The method according to claim 16, wherein each of the entries provides at least one suggestion for improving the assigned attribute value.

18. The method according to claim 14, wherein the specified objective measurements further comprise textual descriptions to be used in the step of assigning attribute values.

19. The method according to claim 18, wherein the textual descriptions identify guidelines for assigning the attribute values using a multi-point scale.

20. The method according to claim 14, further comprising the step of using the generated assessment score to determine whether the IT package may exit a plan checkpoint.

21. The method according to claim 14, further comprising the step of using the generated assessment score to determine whether the role-specific aspects of the IT component have achieved a predetermined assessment score associated with a special designation.

22. The method according to claim 14, further comprising the step of using the generated assessment score to determine whether the IT component has achieved a predetermined assessment score associated with a special designation.

23. A system for assessing information technology (“IT”) packages for their target market, comprising:
a plurality of criteria that are determined to be important to role-specific perspectives of the IT package in the target market, and at least one attribute that may be used for measuring each of the criteria, wherein the attributes are prioritized in view of their importance to the target market;
objective measurements that are specified for each of the attributes, wherein the measurements are weighted according to the prioritizations; and
means for conducting an evaluation of at least one of the role-specific perspectives of the IT package, further comprising:
means for inspecting a representation of the IT package, with reference to selected ones of the attributes of the at least one role-specific perspectives;
means for assigning attribute values to the selected attributes, according to how the IT package compares to the specified objective measurements for each of the role-specific perspectives;
means for generating an assessment score, for each of the role-specific perspectives of the IT package, from the weighted measurements of the assigned attribute values; and
means for generating a list of recommended actions, the list having an entry for each of the selected attributes for which the assigned attribute value falls below a predetermined threshold.

24. A computer program product for assessing information technology (“IT”) package for their target market, the computer program product embodied on one or more computer-readable media and comprising computer-readable instructions that, when executed on a computer, cause the computer to:
record results of conducting an evaluation of a plurality of role-specific aspects of an IT package, wherein the evaluation further comprises:
inspecting a representation of the IT package, with reference to selected ones of a plurality of attributes for each of the role-specific aspects, wherein the attributes are defined to measure a plurality of criteria that are important to the role-specific aspects in the target market; and
assigning attribute values to the selected attributes, according to how each of the role-specific aspects of the IT package compares to objective measurements which have been specified for each of the attributes; and
use the recorded results to generate an assessment score, for each of the role-specific aspects of the IT package, from the assigned attribute values, wherein the generated assessment score thereby indicates how well the role-specific aspect meets the criteria that are important to the target market.
